(19) United States
(12) Patent Application Publication
(10) Pub. No.: US 2005/0238130 A1
(43) Pub. Date: Oct. 27, 2005

(54) Refueling work platform

(76) Inventors: James E. McCann, Lynchburg, VA (US); Albert J. Lovas, Aurora, CO (US); Melanie S. Ray, Wake Forest, NC (US)

Correspondence Address: VYTAS R. MATAS, 2412 CEDARWOOD RD., PEPPER PIKE, OH, 44124, US

(21) Appl. No.: 11/040,856

(22) Filed: Jan. 21, 2005

Related U.S. Application Data
(60) Provisional application No. 60/540,164, filed on Jan. 29, 2004.

(51) Int. Cl. G21C 19/00

(52) U.S. Cl. 376/260

(57) ABSTRACT

The present invention comprises a refueling work platform for use during reactor refueling operation to allow inspection/repair of the reactor vessel simultaneously with the removal and insertion of fuel cells from and into the reactor due to the personnel ring of the work platform being movable down into the reactor cavity to allow a refueling platform to move over the work platform to provide refueling operations while the personnel on the ring are doing their inspection and repair.

### BACKGROUND OF THE INVENTION

1. Field of the Invention

The present application is generally drawn to refueling work platforms and more particularly to work platforms installed over the reactor cavity during refueling of the reactor which allow in-vessel work to be performed simultaneously with refueling.

2. Description of the Prior Art

Much of the maintenance performed in nuclear power plants is similar to that for conventional non-nuclear systems. This includes equipment lubrication, fluid level checks and adjustments. Because most of the active systems are fluid (water, steam or air) systems, most of the work is performed on pumps, valves, fans and filters. In addition, the electrical distribution systems and the instrument and control (IC) systems require regularly scheduled maintenance. As previously discussed, nuclear systems are unique in that many components are inaccessible.

The reactor vessel and its internals are static components requiring little maintenance. Activities that are performed during each refueling outage focus on the integrity of the reactor vessel. During refueling, the reactor head must be removed from the vessel to gain access to the core. When this is done the irradiated fuel elements are removed and replaced with new active fuel elements. This is also the time when the various vessel components are inspected for wear and defects. The process of fuel removal and vessel inspection was done separately in previous installations.

Reactor platform technology can be divided into two categories. The first category consists of the “Auxiliary Platform” supplied during original plant construction. This platform consisted of a painted carbon steel structure having a structural steel frame and a platform that spanned the reactor cavity and provided a surface from which plant personnel could work over the reactor vessel. In general, the Auxiliary Platform had a rectangular shape when viewed from above and provided no openings in the interior of the platform. The “Auxiliary Platform” moved in one dimension on steel rails embedded in the reactor containment building concrete. Simple motor control was provided for moving the platform along the rails, and a small jib hoist was provided as well.

The second category of platforms comprised an upgraded “Auxiliary Platform”. The upgrades included improved motor controls and a redesign of the platform such that in-vessel work could continue in parallel with fuel movement activities. Design of the Auxiliary Platform was changed to provide a generally circular opening in the interior of the platform plus a clear path for the travel of the Refueling Platform mast. The upgraded “Auxiliary Platforms” still provided only one dimensional motion along the embedded rails.

Both categories of the prior art platforms described above provided some functionality, but also had some inherent limitations to their effectiveness. Auxiliary Platforms originally supplied during plant construction were of a design that limited their usefulness during future fuel movement activities. The “Auxiliary Platform” had to move away from the reactor vessel to make room for the mast on the Refueling Platform. In-vessel work being performed from the “Auxiliary Platform” had to be stopped during core offload and reload. Significant schedule impacts resulted from this limitation in the first “Auxiliary Platform” design.

The design of the second type of “Auxiliary Platforms” was such that fuel handling activities and in-vessel work could be performed in parallel. This was accomplished through several improvements. First, the redesign provided an unobstructed path for the mast on the Refueling Platform and an open area in the interior of the Auxiliary Platform. These improvements provided a travel path for the mast and complete access to any location in the reactor core. Second, the redesign lowered the working elevation of the Auxiliary Platform. The lower elevation allowed workers to stand upright and continue working as the Refueling Platform passed overhead. These improvements provided shorter outage schedules over what was possible before. However, the second type of Auxiliary Platform still had inherent weaknesses.

Lowering the working elevation of the platform caused several problems. First, lowering the working elevation put the workers closer to the radiation source, thus increasing the dose rates in the work area. Second, the lower working elevation caused interference with reactor cavity structures away from the reactor vessel. This became an issue at the start and close of an outage during the reactor head and internals (moisture separator and steam dryer) moves. The “Auxiliary Platform” had to be moved away from the reactor vessel to provide space for the head/internals lifts. However, before the platform could be sufficiently moved away from the vessel, the lowered working elevation would interfere with building structures that divided the reactor cavity from the steam dryer and moisture separator storage areas. The Auxiliary Platform had to be removed in its entirety from its rails or portions of the “Auxiliary Platform” had to be removed and stored elsewhere in the plant for every closure head or internals lift. With storage space at a minimum, only one crane available, and significant time required for disassembly and reassembly of the platform, removal and replacement of the “Auxiliary Platform” was costly, presented logistical challenges and was ultimately undesirable. Third, multiple “man-sized” work stations were provided. The small size of the work station hampered the worker's productivity. Fourth, the access path provided for the Refueling Platform mast caused a discontinuity in the structure that weakened the “Auxiliary Platform”. As a result, additional supports had to be installed in the reactor vessel and/or internals which required additional worker effort and, due to their installation location, fall protection was required. Additionally, since the supports would be underwater at times, another source for hot particles and other contamination was created.

In view of these mentioned problems a new design for a refueling platform was sorely needed which would overcome the mentioned problems.

### SUMMARY OF THE INVENTION

The present invention solves the mentioned problems of the prior art refueling work platforms and others by providing a work platform which is installed into the refueling reactor vessel and/or internals of the reactor so as to leave the fuel elements exposed to allow simultaneous inspection and repair of the cavity and removal and replacement of the fuel elements during the refueling process.

The Refueling Work Platform of the present invention improves upon the desirable design features of the prior art platforms while eliminating the undesirable. First, the number of jib hoists mounted on the platform is increased. This enhances the ability to perform parallel tasks during in-vessel work. Second, shielding is provided in the Personnel Ring of the platform to reduce the dose rate in the personnel work area. Third, the personnel ring on the Refueling Work Platform is constructed to be raised and lowered. When in the “up” position, the Refueling Work Platform safely passes over all obstructions in the reactor cavity. When in the “down” position, the Refueling Work Platform is low enough to provide clearance for the Refueling Platform and mast to be positioned over the refueling platform. All core locations can thus be accessed by the personnel in the personnel ring of the platform during fuel movement operations.

The net result of this invention is that the Refueling Work Platform does not need to be disassembled or removed from the rails and stored elsewhere during the head and internals lifts. This frees critical plant resources (crane and floor space) for other uses.

In view of the above it will be seen that one aspect of the present invention is to provide a reactor refueling platform which is situated above the reactor cavity to allow simultaneous inspection/repair from the work platform during fuel removal and insertion.

Another aspect is to provide a work platform for reactor refueling which has a movable personnel ring to allow free movement of the refueling mast over the work platform.

Yet another aspect is to provide a work platform for reactor refueling which is movably located above the reactor cavity to allow free movement of the work platform outside the reactor cavity.

These and other aspects of the present invention will be more fully understood after a perusal of the following description of the preferred embodiment, when considered along with the accompanying drawings.

### BRIEF DESCRIPTION OF THE DRAWINGS

In the drawings wherein:

FIG. 1 is a pictorial view of the general arrangement of the refueling work platform as mounted on the reactor;

FIG. 2 is a top view of the refueling work platform of FIG. 1;

FIG. 3 is an expanded top view of the refueling work platform of FIG. 1;

FIG. 4 is a perspective view of the refueling work platform with the personnel ring being fully down;

FIG. 5 is a perspective view of the refueling work platform with the personnel ring being fully up;

FIG. 6 is a side view of the refueling work platform with the personnel ring fully down;

FIG. 7 is a side view of the refueling work platform with the personnel ring fully up;

FIG. 8 is an end view of the refueling work platform with the personnel ring fully down;

FIG. 9 is an end view of the refueling work platform with the personnel ring fully up;

FIG. 10 is a side view of the refueling work platform as mounted on the reactor with the personnel ring fully down; and

FIG. 11 is a side view of the refueling work platform as mounted on the reactor with the personnel ring fully up.

### DESCRIPTION OF THE PREFERRED EMBODIMENT

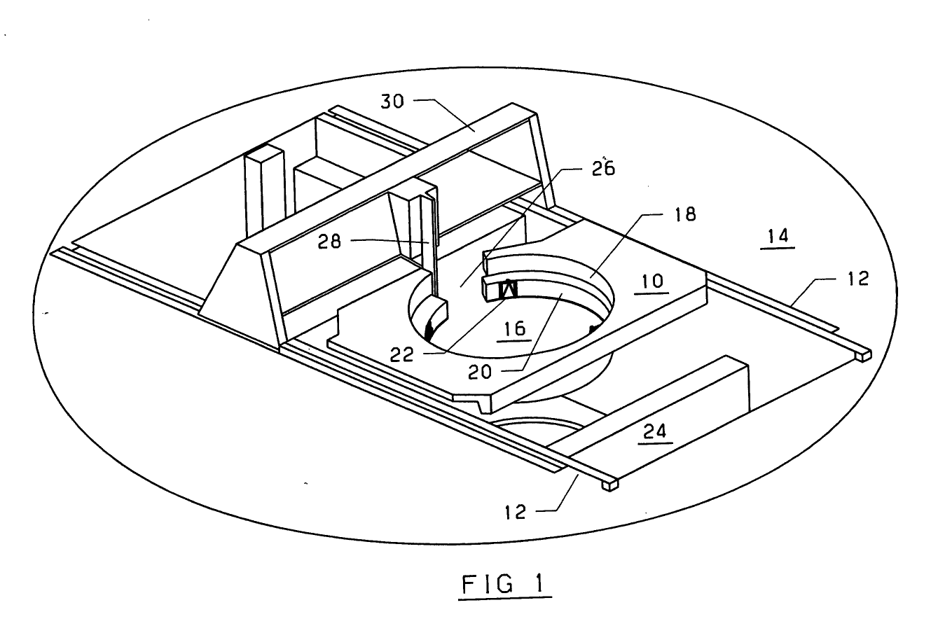

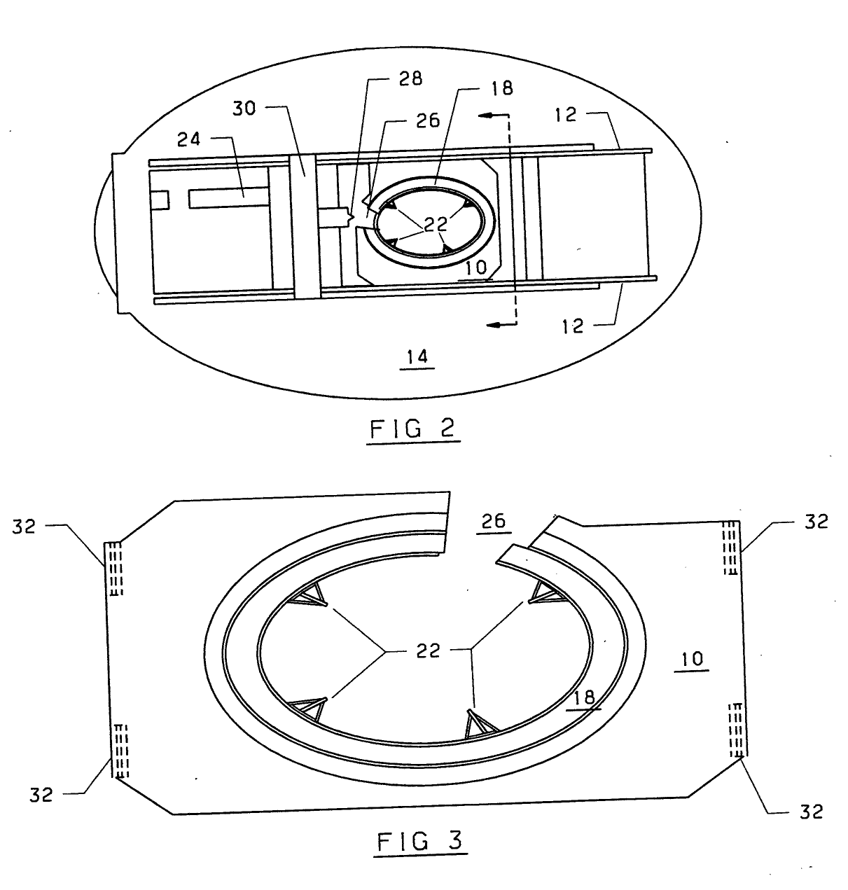

Referring now to the drawings and FIGS. 1-2 in particular a Refueling Work Platform (10) is shown which is movable on rails (12) already constructed across a reactor cavity (14) for the refueling process. The platform (10) has a central opening (16) having an arcuate personnel ring (18) that comprises a sealed 330 degree area with an open top to maximize the available working area for personnel and provide a larger work area than the prior art platforms. The platform has a radiation shielded wall (20) to protect the personnel from radiation. Mounted on the wall (20) are multiple independent jib hoists (22) having an approximate hoisting capacity of 500 pounds. This enhances the ability for personnel to perform multiple in-vessel tasks in parallel. The platform is designed to be rigid enough that secondary supports from existing reactor cavity structures (24) are not required.

The platform has a free entry area (26) located at one end of cavity (16) providing access for the mast (28) of the refueling platform (30) via a free travel path through the entry area (26). The refueling platform moves freely over the work platform (10) to accomplish the refueling process with the personnel on the personnel ring (18) simultaneously performing inspection and repair functions. The design of the platform is such that safety, radiation exposure and outage schedule concerns associated with the prior art are eliminated.

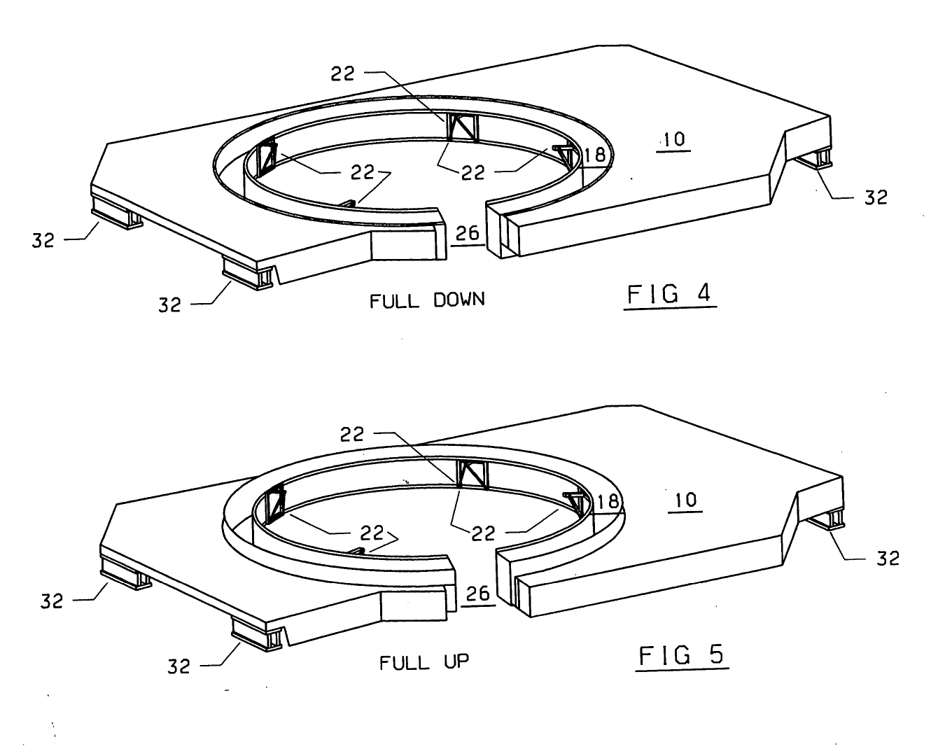

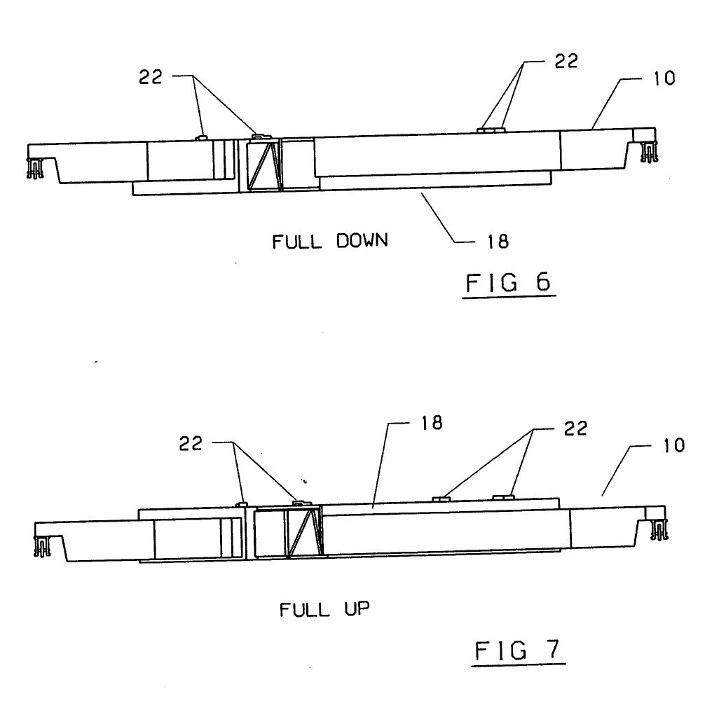

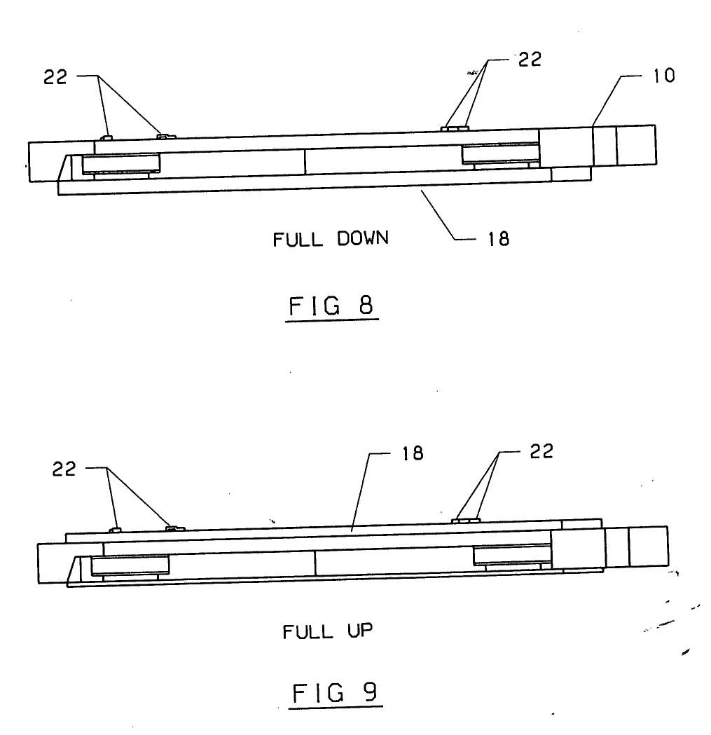

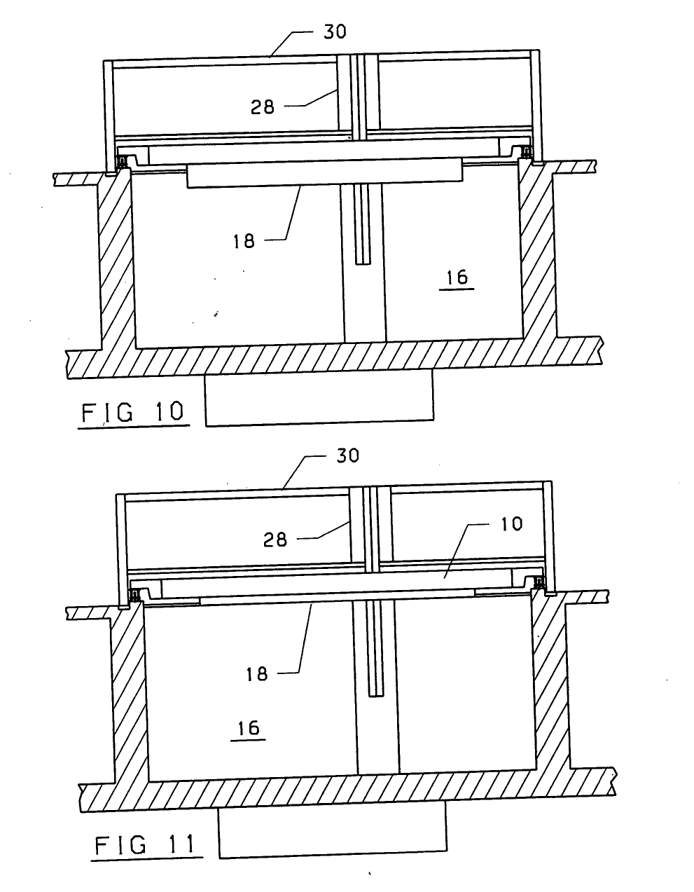

Referring now to FIGS. 4-11, it will be seen that the personnel ring (18) is made to be movable up and down within the platform (10) by known motor means actuated by either a radio controlled or hard-wired pendant operated by the personnel in the personnel ring (18). The work platform (10) is moved over to the cavity (16) on the rails (12) and the ring (18) is lowered to the fully down position to allow the refueling platform (30) to move over the work platform (18) to accomplish the refueling function. The personnel ring (18) of the work platform (10) when lowered to the fully down position allows personnel of six foot stature to simultaneously do the inspection and repair work on the reactor. When the work is finished the refueling platform (30) is moved away and the personnel ring (18) is moved to the fully up position to clear all the reactor obstructions (24) in the fully up position when being moved out of the cavity (16) for storage. As is best seen in FIGS. 4-5, the platform runs on the rails (12) with rail mounts (32) engaged with the rails (12).

It will be seen from the foregoing description that advantages provide by the Refueling Work Platform of the present invention are numerous.

First, worker safety is improved since installation of secondary supports in the reactor cavity is not required.

Second, worker radiation exposure is reduced by:
1. The ability to integrate radiation shielding into the Refueling Work Platform design;
2. The option to incorporate motor controls (traverse and raise/lower) into a radio control unit that can be remotely operated.

Third, outage schedule (and therefore cost) improvements are realized through:
1. provision of additional jib hoists that allow parallel in-vessel activities;
2. elimination of the need to either disassemble or remove the Refueling Work Platform during closure head/reactor internals moves;
3. enhancing he working environment by providing a large work area versus individual “man-sized” work areas;
4. provision of both compressed air and electrical service outlets on the Refueling Work Platform (no need to establish temporary power/air)

Fourth material of construction is compatible with reactor system chemistry.

It will be understood that certain details, obvious modifications and applications have been deleted herein for the sake of conciseness and readability but are fully intended to fall within the scope of the following claims.

1. A refueling work platform system for use in a nuclear power plant during refueling operations comprising:
a work platform having a central cavity and being movable over the reactor cavity during refueling operations;
a continuous personnel ring located around the cavity of said work platform providing a work area for a plurality of personnel inside the vessel; and
said personnel ring being movable within said work platform to a fully down position allowing the refueling operation to continue in parallel with any inspection or repair work being done by the personnel on said personnel ring.

2. A refueling work platform system as set forth in claim 1 including a refueling platform having a mast for removing spent fuel and wherein said personnel ring is arcuate for approximately 330 degrees and has a free entry area located at the end thereof allowing said mast of said refueling platform to enter the reactor cavity.

3. A refueling work platform system as set forth in claim 1 wherein said personnel ring has radiation shielding thereon to protect the personnel therein from radiation.

4. A refueling work platform system as set forth in claim 1 wherein said work platform has a plurality of jib hoists for in-vessel work.

5. A refueling work platform system as set forth in claim 1 wherein said personnel ring is movable to a fully up position within said platform to thereby clear any obstructions within the reactor during removal of said work platform from the reactor cavity.

6. A refueling work platform system as set forth in claim 5 wherein said platform has rail holders for moving said platform along existing rails provided during refueling.

7. A refueling work platform system as set forth in claim 2 wherein said personnel ring when fully lowered into the reactor cavity allows personnel of six foot stature to freely move therein during the refueling process.

8. A refueling work platform system as set forth in claim 7 wherein said work platform includes electrical and pneumatic energy sources for use by the personnel therein.

9. A method of refueling a reactor simultaneously with reactor inspection and repair comprising the steps of:
providing a refueling work platform having a central cavity and an arcuate personnel ring approximately 330 degrees and being movable up and down therein;
moving the refueling work platform over the reactor cavity;
lowering the personnel ring into the cavity to allow inspection and repair operations on the reactor; and
moving a refueling platform over the refueling work platform to simultaneously refuel the reactor.

10. A method of refueling a reactor as set forth in claim 9 including the steps of:
moving the refueling platform away from the reactor cavity;
moving the personnel platform up into the work platform to clear any obstructions in the reactor cavity; and
moving the platform away from the reactor for storage.
